(19) United States
(12) Patent Application Publication
(10) Pub. No.: US 2013/0257122 A1
(43) Pub. Date: Oct. 3, 2013

(54) WHEELCHAIR COVER

(71) Applicant: SURE FIT, INC., (unknown)

(72) Inventor: Brenda K. MILLER, Jersey Shore, PA (US)

(21) Appl. No.: 13/627,856

(22) Filed: Sep. 26, 2012

Related U.S. Application Data
(60) Provisional application No. 61/539,629, filed on Sep. 27, 2011.

(51) Int. Cl. A61G 5/10

(52) U.S. Cl. CPC A61G 5/10
USPC 297/227

(57) ABSTRACT

A wheelchair cover includes a first covering member having a back covering portion configured to cover at least a portion of the back of a wheelchair, a first arm covering portion configured to cover at least a portion of a first arm of the wheelchair, and a second arm covering portion configured to cover at least a portion of a second arm of the wheelchair, a first fastener configured to secure the first arm covering portion to the first arm of the wheelchair, and a second fastener configured to secure the second arm covering portion to the second arm of the wheelchair. It also includes a second covering member having a seat covering portion configured to cover at least a portion of the seat of the wheelchair. The second covering member is removably attachable to the first covering member.

### CROSS-REFERENCE TO RELATED APPLICATIONS

This application claims priority to and the benefit of U.S. Provisional Patent Application No. 61/539,629, which is incorporated by reference in its entirety.

### BACKGROUND

The present disclosure generally relates to wheelchair accessories and more particularly to wheelchair covers providing enhanced fit, stability and comfort.

Wheelchairs have been in use for decades in hospitals, nursing homes, and in homes for personal use. Due to their mechanical parts, wheelchairs generally have an unsightly appearance. Wheelchair covers can provide a neater look for wheelchairs. Wheelchair covers have been used to cover wheelchairs so that they appear as regular slipcovered or upholstered chairs. Some wheelchair covers are one-piece units that cover both the seat and back of the wheelchair. These covers lack universal fit with a multitude of wheelchair sizes. Moreover, the entire cover must be removed and replaced if either the seat portion or the back portion becomes soiled. Also, most of these wheelchair covers do not have an aesthetic appearance. In some cases, the wheelchair user may have to carry or transport medical equipment or other accessories.

Accordingly, there remains a need for different wheelchair covers that, while providing comfort and convenience to a user, also provide an aesthetic look, such that the wheelchair is as attractive as an upholstered or slipcovered piece of furniture. Also, there is a need to ensure that the wheelchair cover remains secured to the wheelchair and does not slide or adjust during regular use.

A need exists for improvement in wheelchair covers. This, and other needs, can be addressed by one or more aspects of the present invention.

### SUMMARY OF THE INVENTION

In one embodiment, a wheelchair cover is provided for a wheelchair comprising a seat, a back, and first and second arms. The wheelchair cover comprises a first covering member comprising: a back covering portion configured to cover at least a portion of the back of the wheelchair, a first arm covering portion configured to cover at least a portion of the first arm of the wheelchair, a second arm covering portion configured to cover at least a portion of the second arm of the wheelchair, a first fastener extending from an inner surface of the first arm covering portion, the first fastener being configured to secure the first arm covering portion to the first arm of the wheelchair, and a second fastener extending from an inner surface of the second arm covering portion, the second fastener being configured to secure the second arm covering portion to the second arm of the wheelchair; and a second covering member comprising: a seat covering portion configured to cover at least a portion of the seat of the wheelchair. The second covering member is removably attachable to the first covering member.

In one aspect, the first fastener comprises a first hook-and-loop fastener strip, and the second fastener comprises a second hook-and-loop fastener strip.

In another aspect, the first fastener comprises a first pair of hook-and-loop fastener strips, including a first hook side strip and a first loop side strip, the first hook side strip and the first loop side strip being directly attached to the inner surface of the first arm covering portion, and the second fastener comprises a second pair of hook-and-loop fastener strips, including a second hook side strip and a second loop side strip, the second hook side strip and the second loop side strip being directly attached to the inner surface of the second arm covering portion.

In another aspect, the first covering member further comprises: a third fastener extending from the inner surface of the first arm covering portion, the third fastener being configured to further secure the first arm covering portion to the first arm of the wheelchair, and a fourth fastener extending from the inner surface of the second arm covering portion, the fourth fastener being configured to further secure the second arm covering portion to the second arm of the wheelchair.

In another aspect, the first fastener is located proximate a first end of the first arm covering portion, the second fastener is located proximate a first end of the second arm covering portion, the third fastener is located proximate a second end of the first arm covering portion, and the fourth fastener is located proximate a second end of the second arm covering portion.

In another aspect, the first fastener and the third fastener are configured to secure the first arm covering portions to the first arm of the wheelchair proximate to respective ends of a first padded arm rest that is attached to the first arm of the wheelchair, and the second fastener and the fourth fastener are configured to secure the second arm covering portions to the second arm of the wheelchair proximate to respective ends of a second padded arm rest that is attached to the second arm of the wheelchair.

In another aspect, the first covering member further comprises: a first extension cover portion extending from a front edge of the first arm covering portion, the first extension cover portion comprising a first extension cover fastener, wherein the first extension cover portion is configured to wrap around a first hand pipe of the wheelchair such that the first arm covering portion is reversibly securable to the first hand pipe via the first extension cover fastener; and a second extension cover portion extending from a front edge of the second arm covering portion, the second extension cover portion comprising a second extension cover fastener, wherein the second extension cover portion is configured to wrap around a second hand pipe of the wheelchair such that the second arm covering portion is reversibly securable to the second hand pipe via the second extension cover fastener.

In another aspect, each of the first and second extension cover fasteners comprises a hook-and-loop fastener strip.

In another aspect, the hook-and-loop fastener of the first extension cover portion is affixed to an inside surface of the first extension cover portion and extends lengthwise along the first extension cover portion, and the hook-and-loop fastener of the second extension cover portion is affixed to an inside surface of the second extension cover portion and extends lengthwise along the second extension cover portion.

In another aspect, each of the hook-and-loop fasteners of the first and second extension cover portions comprises a hook portion and a loop portion, the respective first and second arm covering portions being reversibly securable to the respective first and second hand pipes by attaching the hook portions to the loop portions.

In another aspect, the first arm covering portion comprises a first inner panel and a first outer panel, the first inner panel comprising a first inner panel fastener, the first outer panel comprising a first outer panel fastener, and the first inner panel being reversibly attachable to the first outer panel via the first inner panel fastener and the first outer panel fastener, and the second arm covering portion comprises a second inner panel and a second outer panel, the second inner panel comprising a second inner panel fastener, the second outer panel comprising a second outer panel fastener, and the second inner panel being reversibly attachable to the second outer panel via the second inner panel fastener and the second outer panel fastener.

In another aspect, at least a portion of the first covering member includes a quilted surface.

In another aspect, the first covering member further comprises a pocket located on a rear side of the back covering portion.

In another aspect, the wheelchair cover further comprises a third covering member configured to cover a cushion that is locatable on the seat of said wheelchair.

In another aspect, at least a portion of the third covering member includes a quilted surface.

In another aspect, the first covering member comprises a fabric flap extending from a bottom of the back covering portion, the fabric flap comprising a third fastener on an outside surface of the fabric flap, the wheelchair cover further comprising a third covering member configured to cover a cushion that is locatable on the seat of said wheelchair, the wheelchair cover comprising a fourth fastener on a bottom surface of the third covering member, and the third covering member is removably attachable to the fabric flap of the first covering member by attaching the fourth fastener to the third fastener.

In a second embodiment, a wheelchair cover is provided for a wheelchair comprising a seat, a back, first and second arms, and first and second hand pipes extending from the respective first and second arms. The wheelchair cover comprises a first covering member comprising: a back covering portion configured to cover at least a portion of the back of the wheelchair, a first arm covering portion configured to cover at least a portion of the first arm of the wheelchair, a second arm covering portion configured to cover at least a portion of the second arm of the wheelchair, a first extension cover portion extending from a front edge of the first arm covering portion, the first extension cover portion comprising a first fastener, wherein the first extension cover portion is configured to wrap around the first hand pipe of the wheelchair such that the first arm covering portion is reversibly securable to the first hand pipe via the first fastener, and a second extension cover portion extending from a front edge of the second arm covering portion, the second extension cover portion comprising a second fastener, wherein the second extension cover portion is configured to wrap around the second hand pipe of the wheelchair such that the second arm covering portion is reversibly securable to the second hand pipe via the second fastener; and a second covering member comprising: a seat covering portion configured to cover at least a portion of the seat of the wheelchair. The second covering member is removably attachable to the first covering member.

In one aspect, each of the first and second fasteners comprises a hook-and-loop fastener strip.

In another aspect, the hook-and-loop fastener of the first extension cover portion is affixed to an inside surface of the first extension cover portion along a length of the first extension cover portion, and the hook-and-loop fastener of the second extension cover portion is affixed to an inside surface of the second extension cover portion along a length of the second extension cover portion.

In another aspect, each of the hook-and-loop fasteners of the first and second extension cover portions comprises a hook portion and a loop portion, the respective first and second arm covering portions being reversibly securable to the respective first and second hand pipes by attaching the hook portions to the loop portions.

In another aspect, at least a portion of the first covering member includes a quilted surface.

In another aspect, the first covering member further comprises a pocket located on a rear side of the back covering portion.

In another aspect, the wheelchair cover further comprises a third covering member configured to cover a cushion that is locatable on the seat of said wheelchair.

In another aspect, at least a portion of the third covering member includes a quilted surface.

In another aspect, the first covering member comprises a fabric flap extending from a bottom of the back covering portion, the fabric flap comprising a third fastener on an outside surface of the fabric flap, the wheelchair cover further comprising a third covering member configured to cover a cushion that is locatable on the seat of said wheelchair, the wheelchair cover comprising a fourth fastener on a bottom surface of the third covering member, and the third covering member is directly attachable to the fabric flap of the first covering member by attaching the fourth fastener to the third fastener.

### BRIEF DESCRIPTION OF THE DRAWINGS

One or more preferred embodiments now will be described in detail with reference to the accompanying drawings, wherein the same elements are referred to with the same reference numerals, and wherein,

FIG. 1 is a perspective view of a preferred embodiment of a wheelchair cover in accordance with one or more aspects of the present invention;

FIG. 2 is a detailed perspective view of the wheelchair cover of FIG. 1;

FIG. 3 is a side perspective view of the wheelchair cover of FIG. 1;

FIG. 4 is a rear view of the wheelchair cover of FIG. 1;

FIG. 5 is the fabric pattern used to assemble the back covering portion of the wheelchair cover of FIG. 1;

FIG. 6 is a top view of a second covering member of the wheelchair cover of FIG. 1;

FIG. 7 is a perspective view of a third covering member for use with the wheelchair cover of FIG. 1;

FIG. 8 is a perspective view of the wheelchair cover of FIG. 1, including a third covering member;

FIG. 9 is a front perspective view of a desk-arm type wheelchair cover that includes one or more quilted surfaces;

FIG. 10 is a view of an arm covering portion of the wheelchair cover of FIG. 1, attached to the arms of a wheelchair;

FIG. 11 is another view of the arm covering portion of the wheelchair cover of FIG. 1, attached to the arms of the wheelchair;

FIG. 12 is a view of an extension cover portion of the wheelchair cover of FIG. 1, before being attached around hand pipes of a wheelchair;

FIG. 13 is a view of the extension cover portion of the wheelchair cover of FIG. 1, after being attached around the hand pipes of the wheelchair;

FIG. 14 is another view of the extension cover portion of the wheelchair cover of FIG. 1, after being attached around the hand pipes of the wheelchair, with an outside panel of the arm covering portion not yet attached to an inside panel of the arm covering portion;

FIG. 15 is another view of the extension cover portion of the wheelchair cover of FIG. 1, after being attached around the hand pipes of the wheelchair, with the outside panel of the arm covering portion attached to the inside panel of the arm covering portion;

FIG. 16 is a perspective view of a preferred embodiment of a wheelchair cover in accordance with one or more aspects of the present invention;

FIG. 17 is a detailed perspective view of the wheelchair cover of FIG. 16;

FIG. 18 is a side perspective view of the wheelchair cover of FIG. 16;

FIG. 19 is a top view of a second covering member of the wheelchair cover of FIG. 16;

FIG. 20 is a perspective view of a third covering member for use with the wheelchair cover of FIG. 16;

FIG. 21 is a view of an arm covering portion of the wheelchair cover of FIG. 18, showing a rear side fastener attached around the arm of a wheelchair;

FIG. 22 is a view of an arm covering portion of the wheelchair cover of FIG. 18, showing a front side fastener attached around the arm of a wheelchair;

FIG. 23 is a perspective view of a standard-arm wheelchair cover that includes one or more quilted surfaces.

### DETAILED DESCRIPTION

Referring now to the drawings, one or more preferred embodiments of the present invention are next described. The following description of one or more preferred embodiments is merely exemplary in nature and is in no way intended to limit the invention, its implementations, or uses.

As a general matter, one or more preferred embodiments of the present invention provide a wheelchair cover that, while providing comfort and convenience to a user, can make a wheelchair look as an upholstered or slipcovered piece of furniture. Many aspects and features of the present invention further relate to functional enhancements to a wheelchair cover, including functional enhancements to a wheelchair cover that provide for improved fit, stability, and adjustability. Several aspects and features of the present invention as discussed hereinbelow are similar in certain respects to a wheelchair cover disclosed in U.S. Pat. No. 7,278,649 to Daniels, the entirety of which is hereby incorporated by reference herein.

### Desk-Arm Embodiment

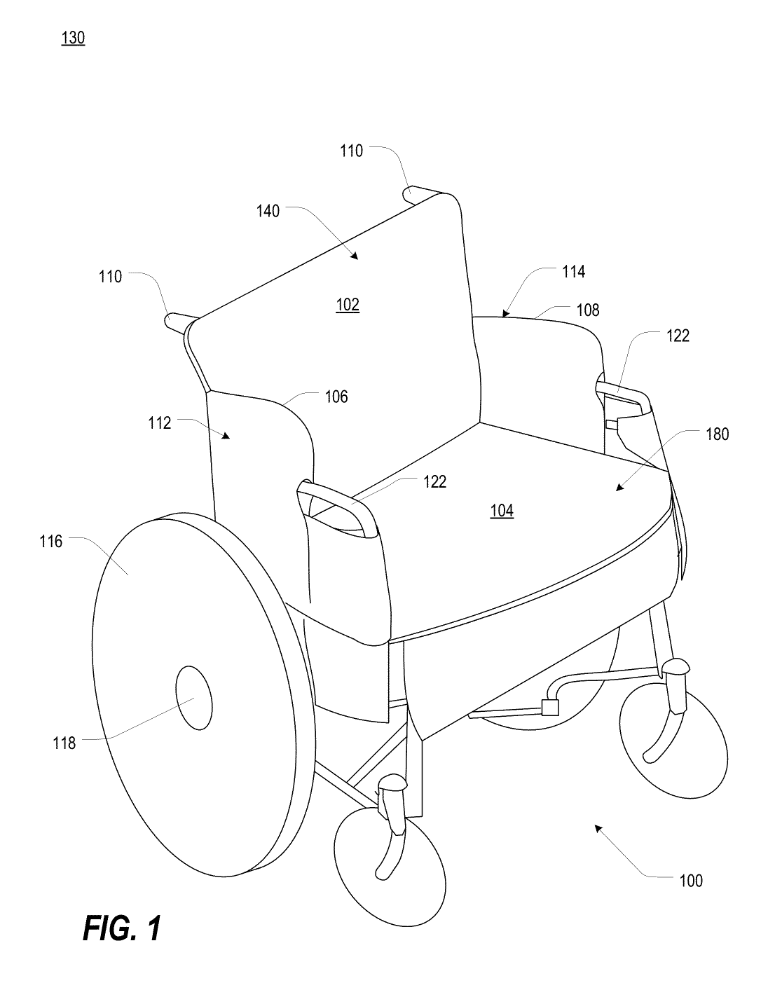

Referring now to FIGS. 1-14, a wheelchair 100 is covered with a wheelchair cover 130. The wheelchair 100 is a desk-arm type wheelchair, and as used herein, a desk-arm type wheelchair refers to a wheelchair that has a first arm 106 extending from a back 102 on a first side 112 of the wheelchair 100, a second arm 108 extending from the back 102 on a second side 114, a seat 104, and hand pipes 122 extending from the arms 106, 108 at a height lower than a height at which the arms extend form the back 102 of the wheelchair 100.

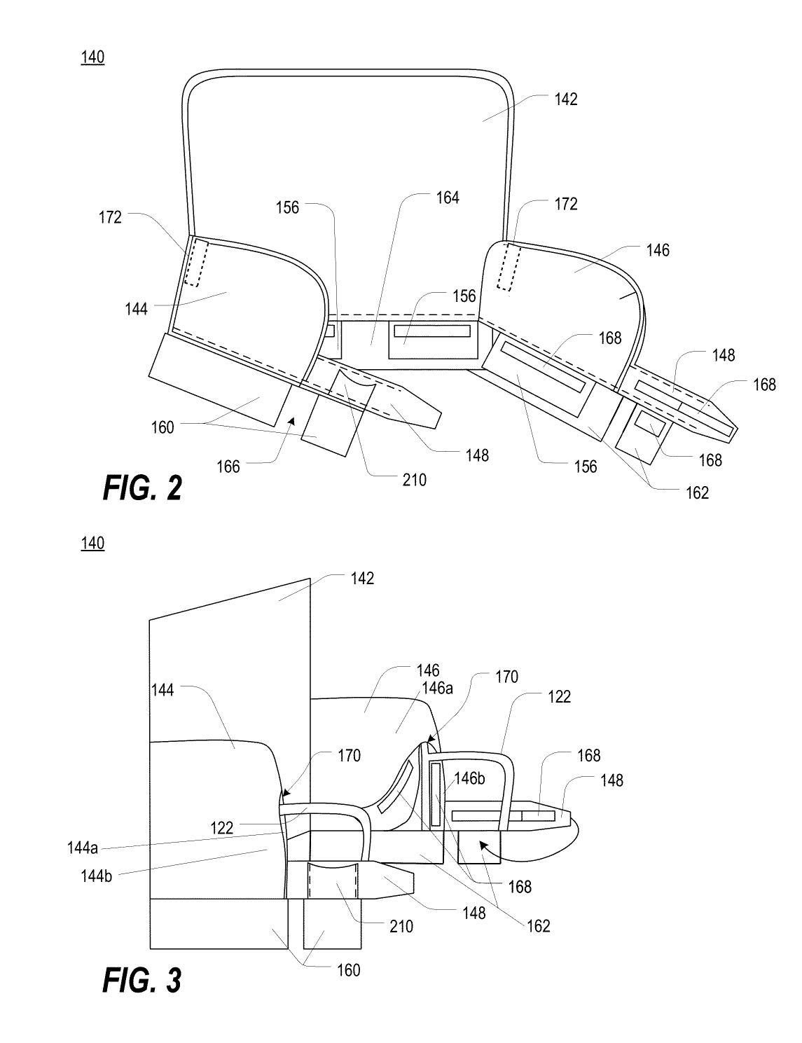

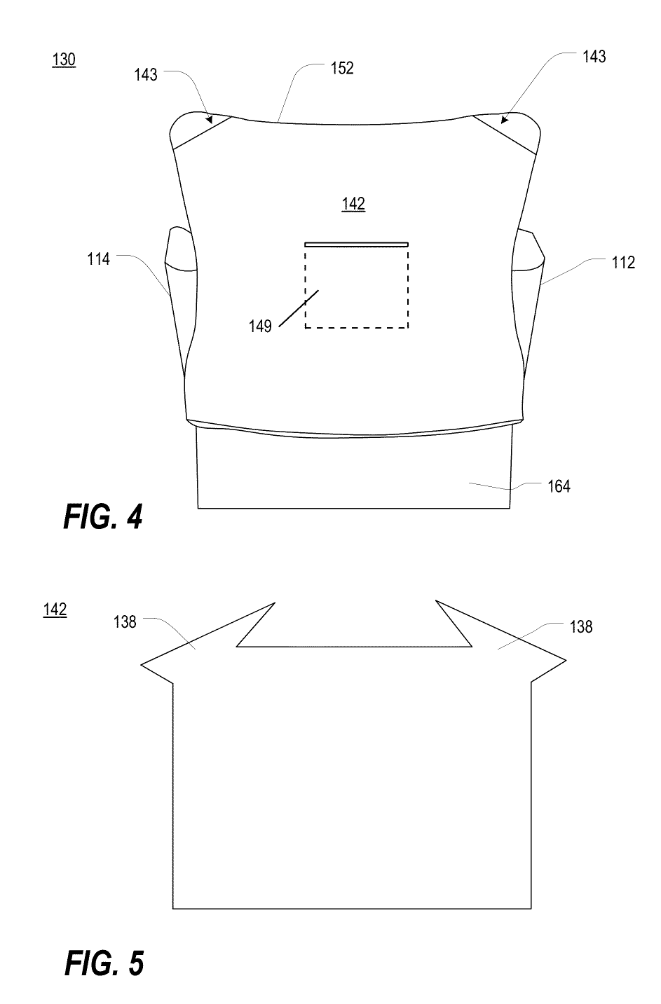

FIG. 1 is a perspective view of a preferred embodiment of a wheelchair cover 130 in accordance with one or more aspects of the present invention. FIG. 2 is a detailed perspective view of the wheelchair cover 130 of FIG. 1. FIG. 3 is a side perspective view of the wheelchair cover 130 of FIG. 1. FIG. 4 is a rear view of the wheelchair cover 130 of FIG. 1. FIG. 5 is the fabric pattern used to assemble the back covering portion 142 of the wheelchair cover 130 of FIG. 1.

As seen in detail in FIGS. 1-4, the wheelchair cover 130 comprises a first covering member 140 having a back covering portion 142, a first arm covering portion 144, and a second arm covering portion 146. The back covering portion 142 has two handle openings 143 on either side of a top end 152, such that, the first covering member 140 slips on easily over back handles 110, sliding down between the first side 112 and the second side 114, thereby the back covering portion 142 covering the back 102, the first arm covering portion 144 covering the first arm 106, and the second arm covering portion 146 covering the second arm 108.

FIG. 5 illustrates the back covering portion 142 prior to being attached to the first covering member 140. As seen, the back covering portion 142 includes extension portions 138 adapted to fold into the inside of the back covering portion 142 such that the extension portions are located within the handle openings 143 and hidden from view, as seen in FIG. 4.

The first covering member 140 further includes a first side skirt 160 extending from the first arm covering portion 144 up to a wheel axle 118 of wheels 116 covering the first side 112 of the wheelchair 100; a second side skirt 162 extending form the second arm covering portion 146 up to the wheel axle 118 of wheels 116 covering the second side 114 of the wheelchair 100; and a back skirt 164 extending from the back covering portion 142 up to the wheel axle 118 of the wheels 116 covering a back side of the wheelchair 100. The first side skirt 160 and/or the second side skirt 162 may be split to form an opening 166 to allow access to control elements such as brake handles and the like, on the first side 112 and also on the second side 114 of the wheelchair 100.

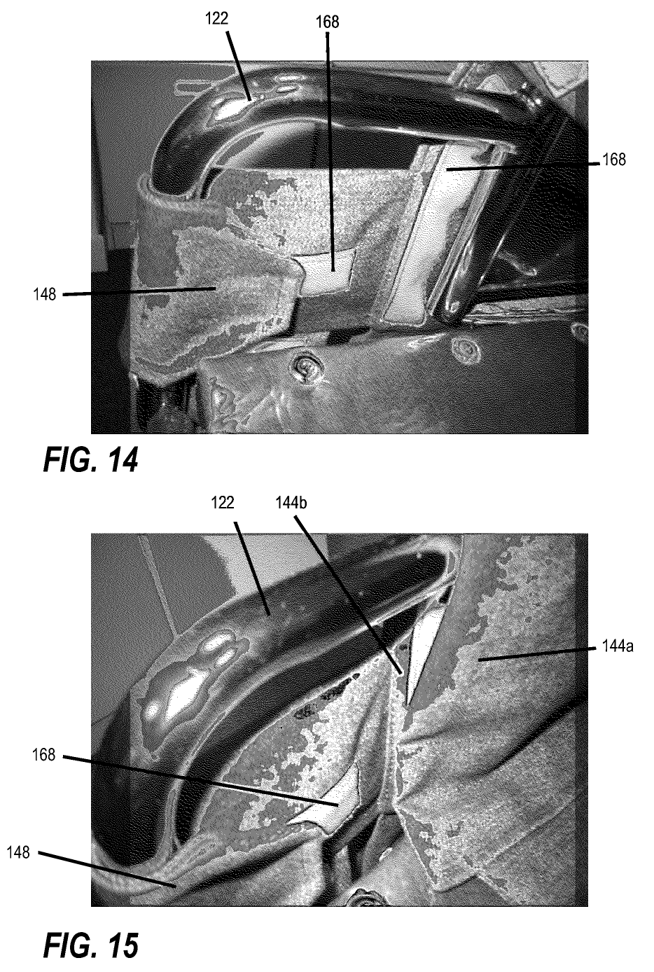

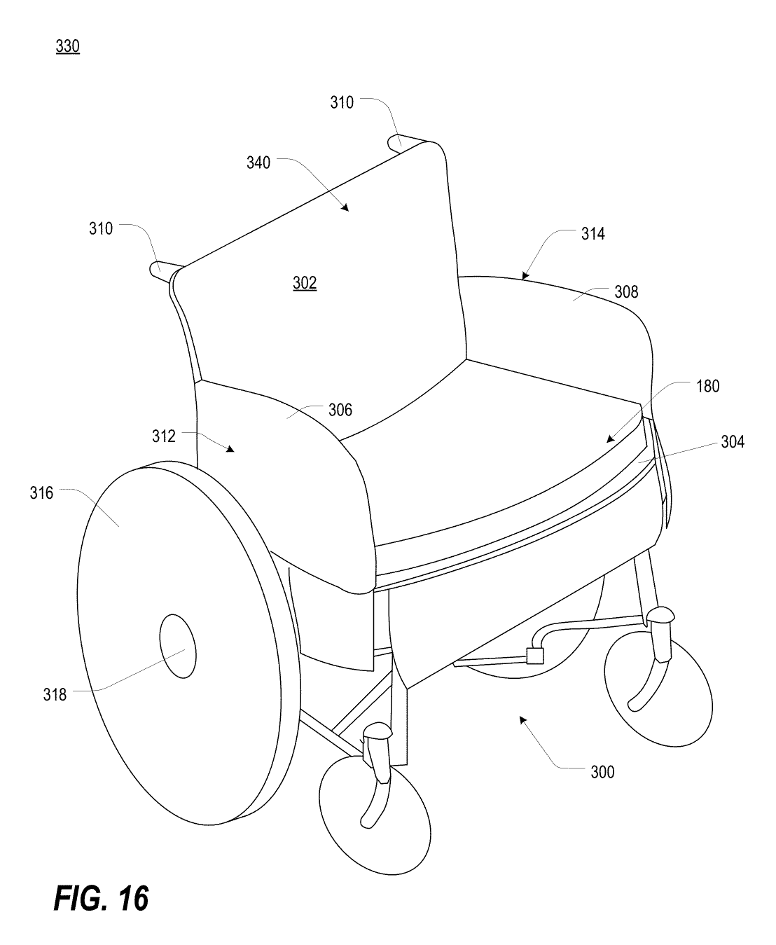

As best seen in FIGS. 1 and 3, each of the arm covering portions 144, 146 includes an opening 170 where the hand pipes 122 are exposed. The interior of the arm covering portions 144, 146 proximate the opening 170 include a hook and loop fastener 168 that keeps the opening 170 in a closed orientation around the hand pipe 122. This is further illustrated in FIGS. 14 and 15, which are photographic views of the wheelchair cover 130 of FIG. 1. The opening 170 and the associated fastener 168 enhance the fit, stability, and adjustability of the wheelchair cover 130 by allowing the wheelchair cover 130 to more securely fit a wider variety of wheelchairs with hand pipes 122 of various heights and orientations.

The first arm covering portion 144 may comprise a first inner panel 144a and a first outer panel 144b, the first inner panel 144a comprising a first inner panel fastener 168, the first outer panel comprising a first outer panel fastener 168, and the first inner panel 144a being reversibly attachable to the first outer panel 144b via the first inner panel fastener 168 and the first outer panel fastener 168. The second arm covering portion may comprise a second inner panel 146a and a second outer panel 146b, the second inner panel 146a comprising a second inner panel fastener 168, the second outer panel 146b comprising a second outer panel fastener 168, and the second inner panel 146a being reversibly attachable to the second outer panel 146b via the second inner panel fastener 168 and the second outer panel fastener 168.

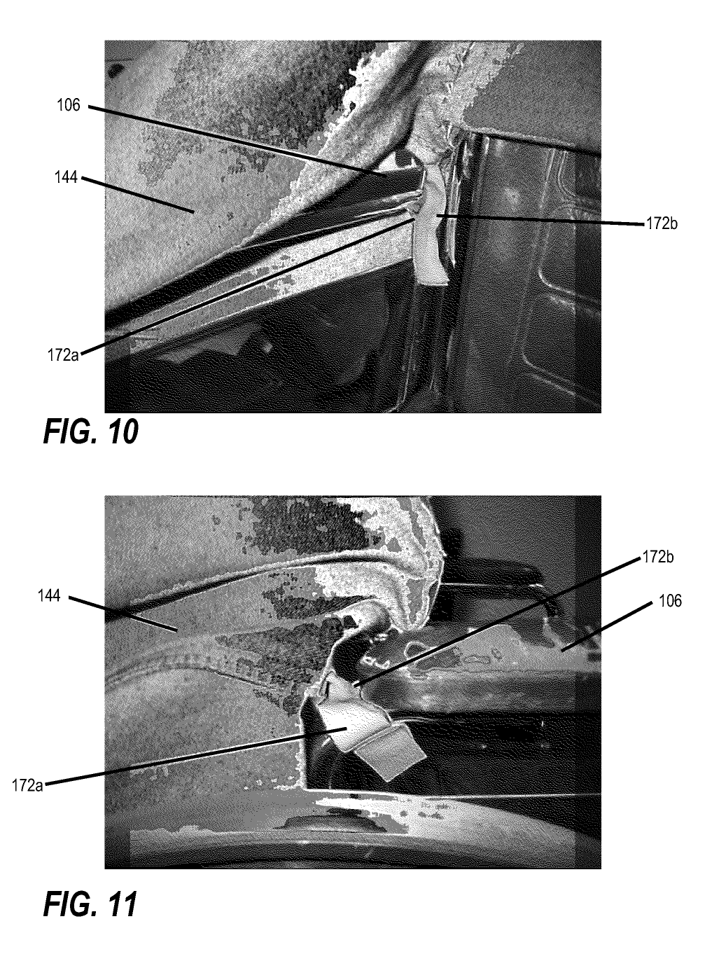

As best seen in FIG. 2, the interior of each of the arm covering portions 144, 146 includes an arm cover fastener 172 having hook and loop strips to securely fasten the arm covering portions 144, 146 to the wheelchair arms 106, 108. The fasteners 172 prevent unwanted shifting of the wheelchair cover 130 during regular use. This is further illustrated in FIGS. 10 and 11, which are views of the wheelchair cover 130 of FIG. 1.

A first fastener 172 may extend from an inner surface of a first arm covering portion 144, the first fastener 172 being configured to secure the first arm covering portion 144 to the first arm of the wheelchair. A second fastener 172 may extend from an inner surface of a second arm covering portion 146, the second fastener 172 being configured to secure the second arm covering portion 146 to the second arm of the wheelchair. One or both of the first and second fasteners 172 may comprise a hook-and-loop fastener strip.

FIG. 2 shows a fastener 172 that includes only a single strip. The single strip fastener may include both a hook side and a loop side of a hook-and-loop fastener strip, such that the single strip may be wrapped around the arms 106, 108 and the hook side may be fastened to the loop side. Alternatively, each fastener may comprise a pair of hook-and-loop fastener strips 172, including a first hook side strip 172a and a first loop side strip 172b, the first hook side strip 172a and the first loop side 172b strip being directly attached to the inner surface of the first arm covering portion 144, 146, as shown, for example, in FIGS. 10 and 11.

While FIGS. 2, 10, and 11 show fasteners 172 that include hook-and-loop fastener strips, other types of fasteners 172 are possible. For example, the fastener may include one or more strings or cords that are tied to the arms 106, 108. The fastener 172 may alternatively include elastic bands or loops. The type of fastener 172 is not particularly limited, as long as the fastener can be used to secure the arm covering portions 144, 146 to the arms 106, 108 of the wheelchair. A single wheelchair cover may include multiple types of fasteners 172. A single wheelchair cover 130 may include multiple types of fasteners 172.

Each of the arm covering portions 144, 146 may include multiple fasteners 172. For example, each of the arm covering portions 144, and 146 may include a fasteners 172 on both the front and rear sides of the arm covering portions 144, and 146. When multiple fasteners 172 extend from each arm covering portion 144, 146, each of the fasteners 172 may include multiple fastener strips, as discussed above. Thus, each arm covering portion 144, 146 may have, for example, four fastening strips extending therefrom: two strips on the front side of the arm covering portion 144, 146, and two strips on the rear side of the arm covering portion 144, 146.

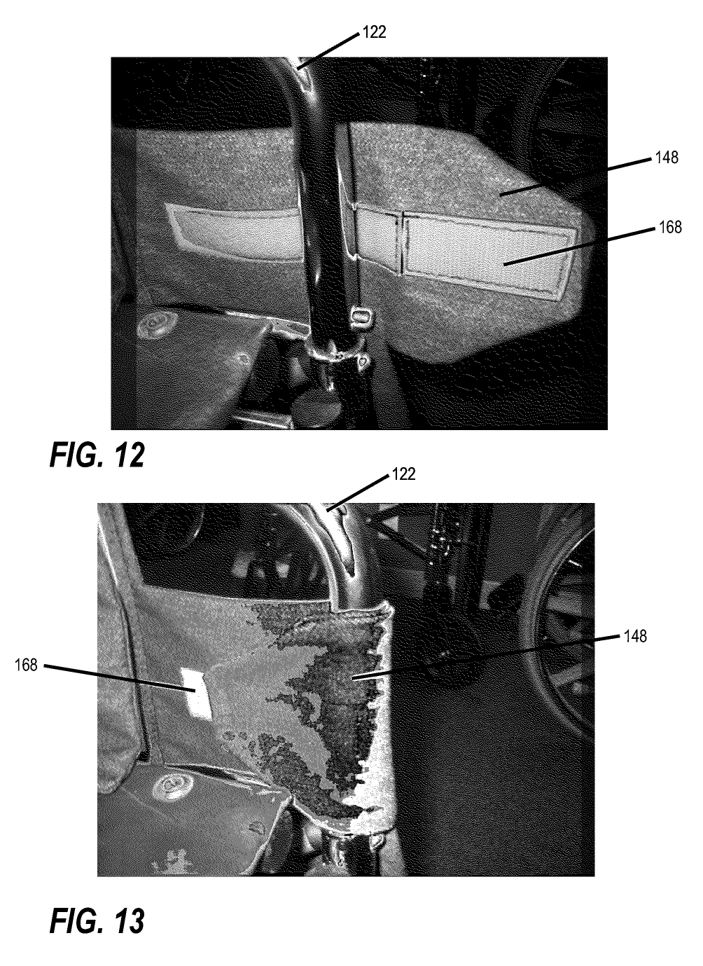

The first covering member 140 for the ‘desk-arm’ type wheelchair 100 further comprises extension cover portions 148 that wrap around a portion of hand pipes 122 along the length of hand pipes 122. A remaining portion of the hand pipes 122 is not covered and may be held by a wheelchair user for controlling the movement of the wheelchair 100. An inner surface of the extension cover portion 148 includes a hook and loop fastener 168. As the extension cover portion 148 is wrapped around the hand pipe 122, the hook portion of the fastener 168 is attached to the loop portion of the fastener 168 to secure the extension cover portion 148 around the hand pipe 122, as best seen in FIGS. 1 and 3. This is further illustrated in FIGS. 12 and 13, which are photographic views of the wheelchair cover 130 of FIG. 1. The extension cover portions 148 enhance both the stability and the adjustability of the wheelchair cover 130 by allowing the wheelchair cover 130 to fit and cover wheelchairs having hand pipes 122 of various lengths or heights.

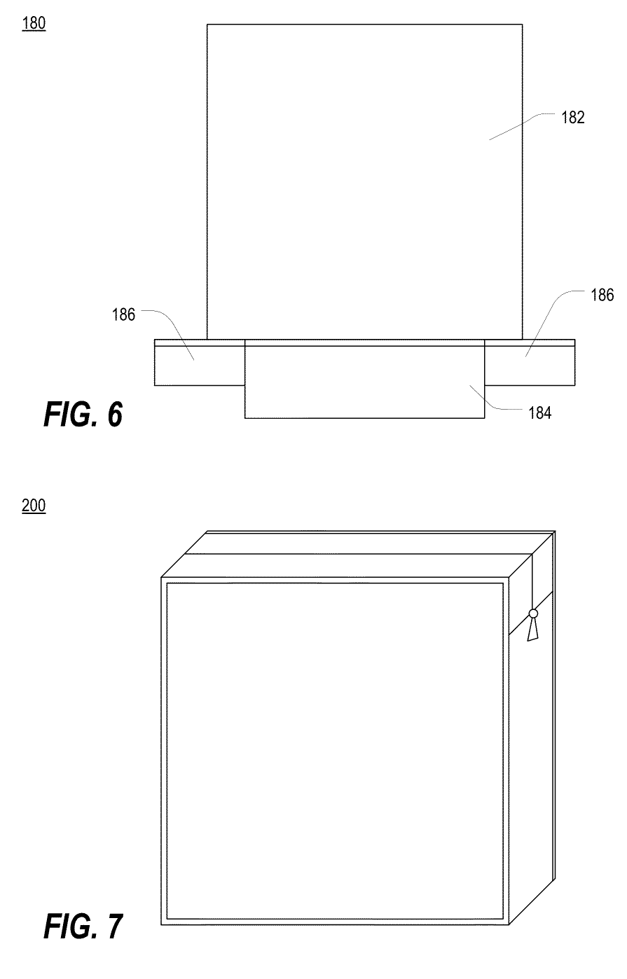

FIG. 6 is a top view of a second covering member 180 of the wheelchair cover 130 of FIG. 1. The wheelchair cover 130 further comprises a second covering member 180 having a seat covering portion 182 and a front skirt 184. The second covering member 180 may be removably attached to the first covering member 140 using attachment means such that the seat covering portion 182 covers the seat 104 and the front skirt 184 covers a front side of the wheelchair 100. Useful attachment means include, but are not limited to, hook and loop, snaps, buttons, zippers, and the like. For example, the first covering member 140 has fabric flaps 156 on each side at the bottom end. The fabric flaps 156 include the hook portion of a hook and loop fastener 168 adapted to attached to the loop portion of the hook and loop fastener located on the bottom side (not shown) of the second covering member 180. Since the second covering member 180 covering the seat 104 can be easily detached from the first covering member 140, the second covering member 180 can be sent for cleaning without having to remove the first covering member 140 from the wheelchair 100.

The second covering member 180 further includes fabric flaps 186 with hook and loop adapted to attach to hook and loop on an interior portion of the second side skirt 162. The fabric flaps 186 are distanced between the front skirt 184 and side skirt 162 to accommodate a pipe (not shown) or footplates (not shown). The front skirt 184 would fall between the pipe (not shown) on either side, when footplates (not shown) are attached. Optionally, a gap (not shown) is left open at a back of the seat covering portion 182 to enable a person closing up the wheelchair 100 to get a grip on the seat 104.

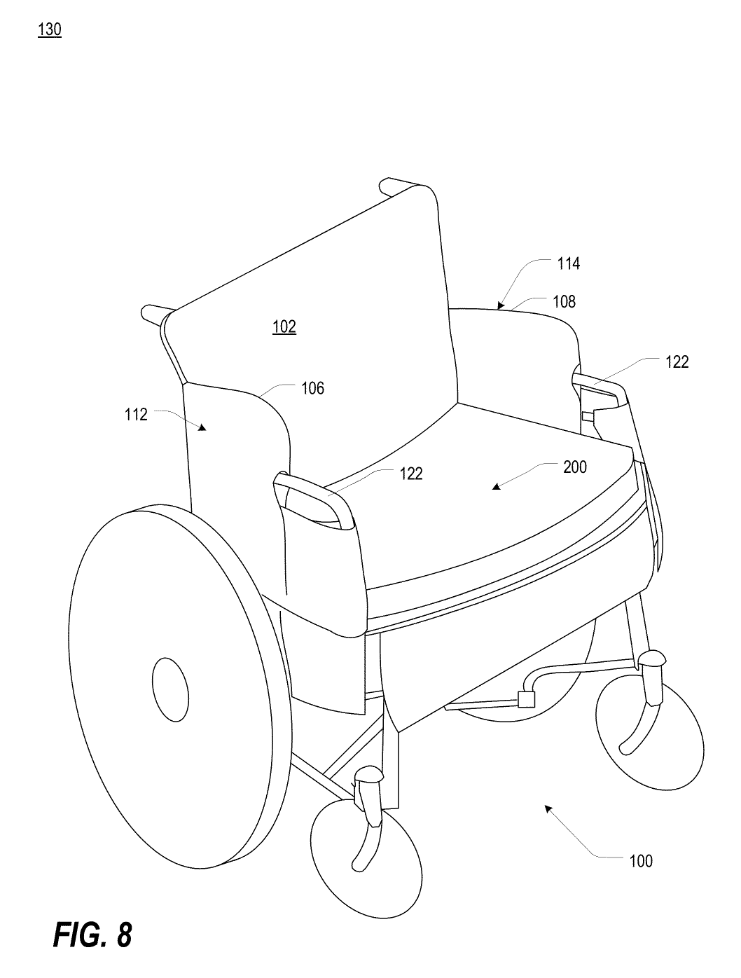

As seen in FIG. 8, the wheelchair 100 may include a cushion that can be placed on the seat 104 of the wheelchair 100. In such embodiments, the wheelchair cover 130 further comprises a third covering member 200 for covering the cushion. FIG. 7 is a perspective view of a third covering member 200 for use with the wheelchair cover 130 of FIG. 8. The third covering member 200 includes an opening to allow insertion of a cushion. The member 200 further includes a zippered closure to keep the cushion disposed therein.

The wheelchair cover 130 may have pockets built into one or more members that can be used to hold a variety of items, such as the user's accessories, medical items, and the like. The ‘desk-arm’ type wheelchair 100 includes pockets 210 on the exterior of the extension cover portions 148. As used herein, an outside surface of extension cover portions 148 is a surface facing the wheels 116 and not facing the seat 104 of the wheelchair 100. The first covering member 140 may have a pocket 149 located on a rear side of the back covering portion 142.

The wheelchair cover 130 may be available in different sizes to fit to dimensions of different available wheelchairs.

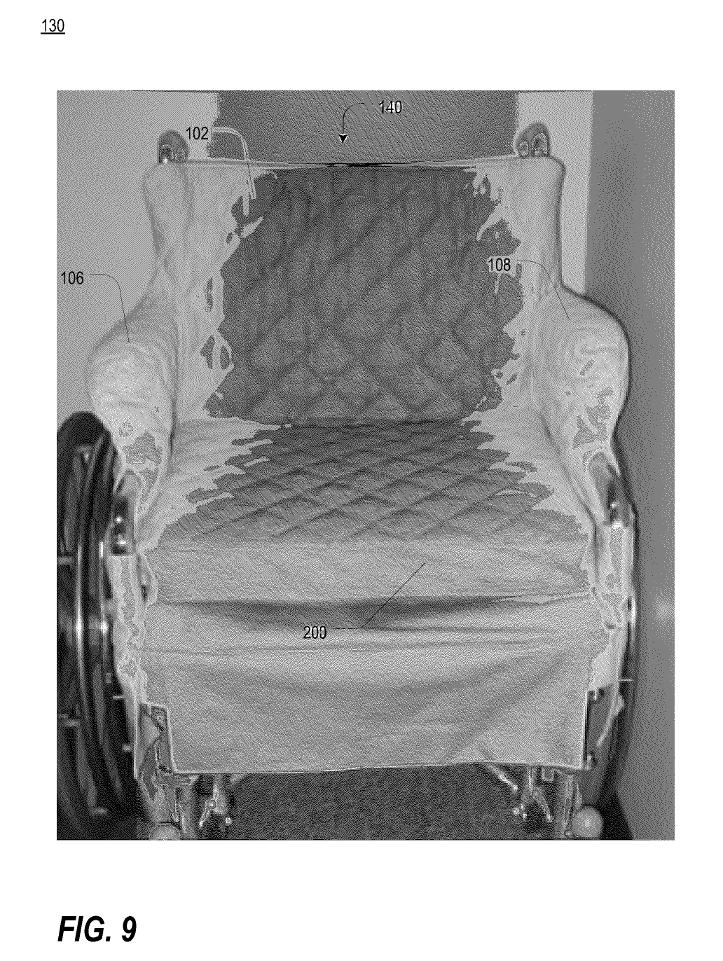

FIG. 9 is a photographic view of a desk-arm type wheelchair cover 130 that includes one or more quilted surfaces. As seen in FIG. 9, the back 102 and arms 106, 108 of the first covering member 140 and the top of the third covering member 200 include quilted surfaces.

### Full-Arm Embodiment

Referring now to FIGS. 16-23, a wheelchair 300 is covered with a wheelchair cover 330. The wheelchair 300 is a full-arm type wheelchair, and as used herein, refers to a wheelchair that has a first arm 306 extending from a back 302 on a first side 312 of the wheelchair 300 and a second arm 308 extending from the back 302 of a second side 314 of the wheelchair 300, and a seat; and does not have any kind of hand pipes. When comparing the desk-arm type wheelchair 100 with full-arm type wheelchair 300, it can be seen that desk-arm type wheelchair 100 has shorter arm lengths than the full-arm type wheelchair 300, since a part of the length on the sides is occupied by a length of the hand pipes 122 of the wheelchair 100.

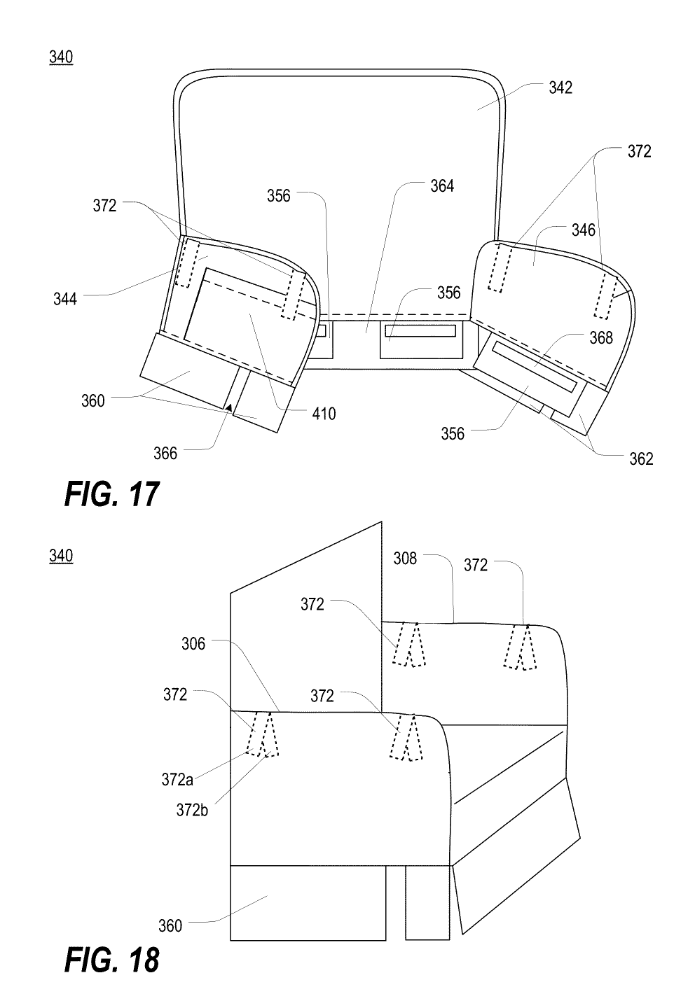

FIG. 16 is a perspective view of a preferred embodiment of a wheelchair cover 330 in accordance with one or more aspects of the present invention. FIG. 17 is a detailed perspective view of the wheelchair cover 330 of FIG. 16. FIG. 18 is a side perspective view of the wheelchair cover 330 of FIG. 16.

As seen in detail in FIGS. 16-18, the wheelchair cover 330 is similar in many respects to the wheelchair cover 130, and comprises a first covering member 340 having a back covering portion 342, a first arm covering portion 344, and a second arm covering portion 346. Similar to the wheelchair cover 130, the back covering portion 342 has two handle openings on either side of a top end, such that, the first covering member 340 slips on easily over back handles 310, sliding down between the first side 312 and the second side 314, thereby the back covering portion 342 covering the back 302, the first arm covering portion 344 covering the first arm 306, and the second arm covering portion 346 covering the second arm 308.

The first covering member 340 further has a first side skirt 360 extending from the first arm covering portion 344 up to a wheel axle 318 of wheels 316 covering the first side 312 of the wheelchair 300; a second side skirt 362 extending form the second arm covering portion 346 up to the wheel axle 318 of wheels 316 covering the second side 314 of the wheelchair 300; and a back skirt 364 extending from the back covering portion 342 up to the wheel axle 318 of the wheels 316 covering a back side of the wheelchair 300. The first side skirt 360 and/or the second side skirt 362 may be split to from an opening 366 to allow access to control elements such as brake handles and the like, on the first side 312 and also on the second side 314 of the wheelchair 300.

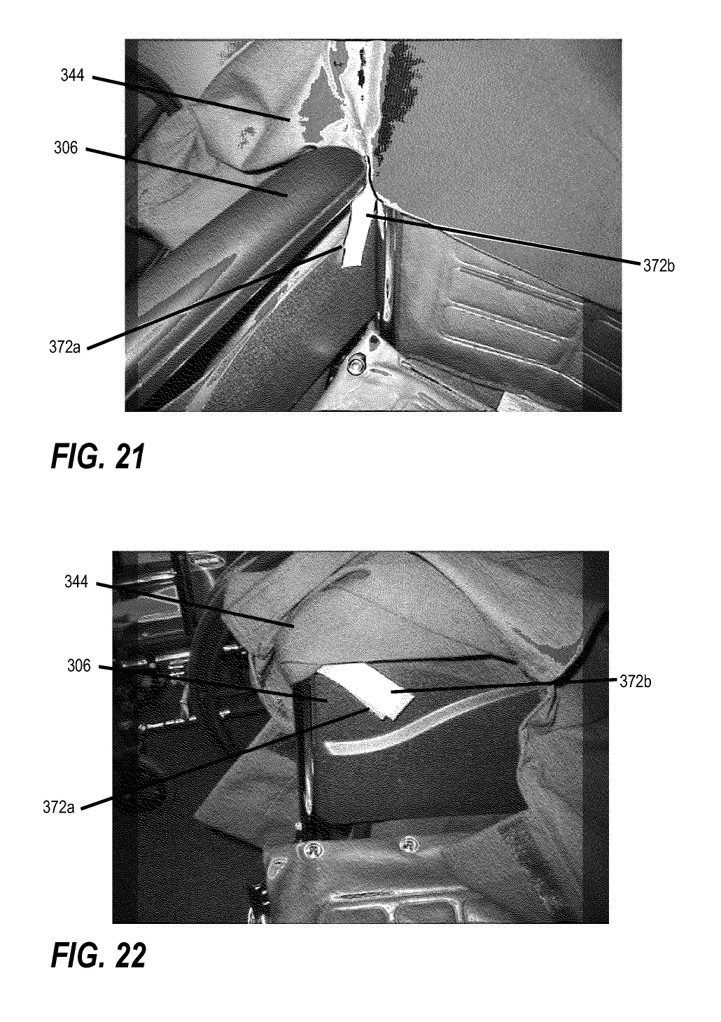

As illustrated in FIGS. 17 and 18, the interior of each of the arm covering portions 344, 346 include two arm cover fasteners 372 having hook and loop strips to securely fasten the arm covering portions 344, 346 to the wheelchair arms 306, 308. Most wheelchairs arms 306, 308 include padded arm rests (not shown). The arm cover fasteners 372 may be strategically positioned to attach to the wheelchair arms 306, 308 proximate the ends of the padded arm rests, which greatly enhances the fit and stability of the wheelchair cover 330. The fasteners 372 prevent unwanted shifting of the wheelchair cover 330 during regular use. This is further illustrated in FIGS. 21 and 22, which are photographic views of the wheelchair cover 330 of FIG. 16.

A first fastener 372 may extend from an inner surface of a first arm covering portion 344, the first fastener 372 being configured to secure the first arm covering portion 344 to the first arm of the wheelchair. A second fastener 372 may extend from an inner surface of a second arm covering portion 346, the second fastener 372 being configured to secure the second arm covering portion 346 to the second arm of the wheelchair. One or both of the first and second fasteners 372 may comprise a hook-and-loop fastener strip.

FIG. 17 shows a fastener 372 that includes only a single strip. The single strip fastener may include both a hook side and a loop side of a hook-and-loop fastener strip, such that the single strip may be wrapped around the arms 306, 308 and the hook side may be fastened to the loop side. Alternatively, each fastener 372 may comprise a pair of hook-and-loop fastener strips 372, including a first hook side strip 372a and a first loop side strip 372b, the first hook side strip 372a and the first loop side 372b strip being directly attached to the inner surface of the first arm covering portion 344, 346, as shown, for example, in FIG. 18.

While FIGS. 17 and 18 show fasteners 372 that include hook-and-loop fastener strips, other types of fasteners are possible. For example, the fastener 372 may include one or more strings or cords that are tied to the arms 306, 308. The fastener 372 may alternatively include elastic bands or loops. The type of fastener 372 is not particularly limited, as long as the fastener can be used to secure the arm covering portions 344, 346 to the arms 306, 308 of the wheelchair. A single wheelchair 330 cover may include multiple types of fasteners 372.

Each of the arm covering portions 344, 346 may include multiple fasteners 372. For example, each of the arm covering portions 344, and 346 may include a fasteners 372 on both the front and rear sides of the arm covering portions 344, and 346. When multiple fasteners 372 extend from each arm covering portion 344, 346, each of the fasteners 372 may include multiple fastener strips, as discussed above. Thus, each arm covering portion 344, 346 may have, for example, four fastening strips extending therefrom: two strips on the front side of the arm covering portion 344, 346, and two strips on the rear side of the arm covering portion 344, 346.

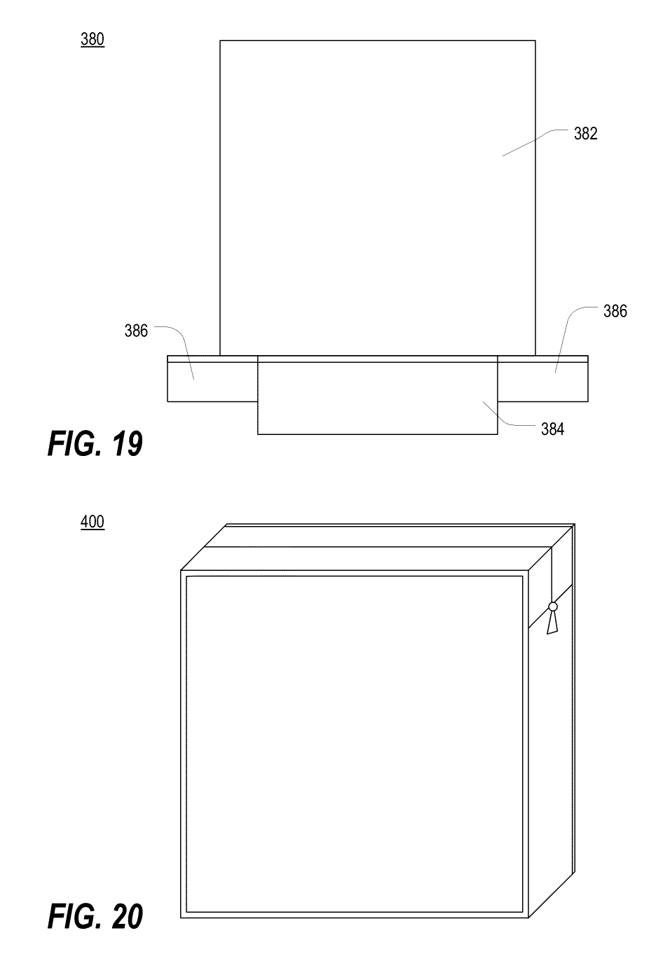

FIG. 19 is a top view of a second covering member 380 of the wheelchair cover 330 of FIG. 16. The wheelchair cover 330 further comprises a second covering member 380 having a seat covering portion 382 and a front skirt 384. The second covering member 380 may be removably attached to the first covering member 340 at a bottom end on the first side 312 and the second side 314 using attachment means, such that the seat covering portion 382 covers the seat 304 and the front skirt 384 covers a front side of the wheelchair 300. Useful attachment means include, but are not limited to, hook and loop, snaps, buttons, zippers, and the like. For example, the first covering member 340 has fabric flaps 356 on each side at the bottom end. The fabric flaps 356 include the hook portion of a hook and loop fastener 368 adapted to attach to the loop portion of the hook and loop fastener located on the bottom side (not shown) of the second covering member 380. Since the second covering member 380 covering the seat 304 can be easily detached from the first covering member 340, the second covering member 380 can be sent for cleaning without having to remove the first covering member 340 from the wheelchair 300.

The second covering member 380 further has fabric flaps 386 with hook and loop adapted to attach to hook and loop on an interior portion of the second side skirt 362. The fabric flaps 386 are distanced between the front skirt 384 and side skirt 362 to accommodate a pipe (not shown) of footplates (not shown). The front skirt 384 would fall between the pipe (not shown) on either side, when footplates (not shown) are attached. Optionally, a gap (not shown) is left open at a back of the seat covering portion 382 to enable a person closing up the wheelchair 300 to get a grip on the seat.

As seen in FIG. 16, the wheelchair 300 may further have a cushion that can be placed on the seat of the wheelchair 300. In such embodiments, the wheelchair cover 330 further comprises a third covering member 400 for covering the cushion. FIG. 20 is a perspective view of a third covering member 400 for use with the wheelchair cover 330 of FIG. 16. The third covering member 400 includes an opening to allow insertion of a cushion. The member 400 further includes a zippered closure to keep the cushion disposed therein.

The wheelchair cover 330 may have pockets built into one or more members that can be used to hold a variety of items, such as the user's accessories, medical items, and the like. The ‘full-arm’ type wheelchair 300 has patch pockets 410 attached (e.g., stitched) to an outside surface of the first arm covering portion 344 and the second arm covering portion 346. As used herein, an outside surface of the first arm covering portion 344 and second arm covering portion 346 is a surface facing the wheels 316 and not facing the seat (not shown) of the wheelchair 300. The first covering member 340 may have a pocket located on a rear side of the back covering portion 342. This pocket may be configured similarly to the pocket 149 discussed above with respect to the desk-arm embodiment.

The wheelchair cover 330 may be available in different sizes to fit to dimensions of different available wheelchairs.

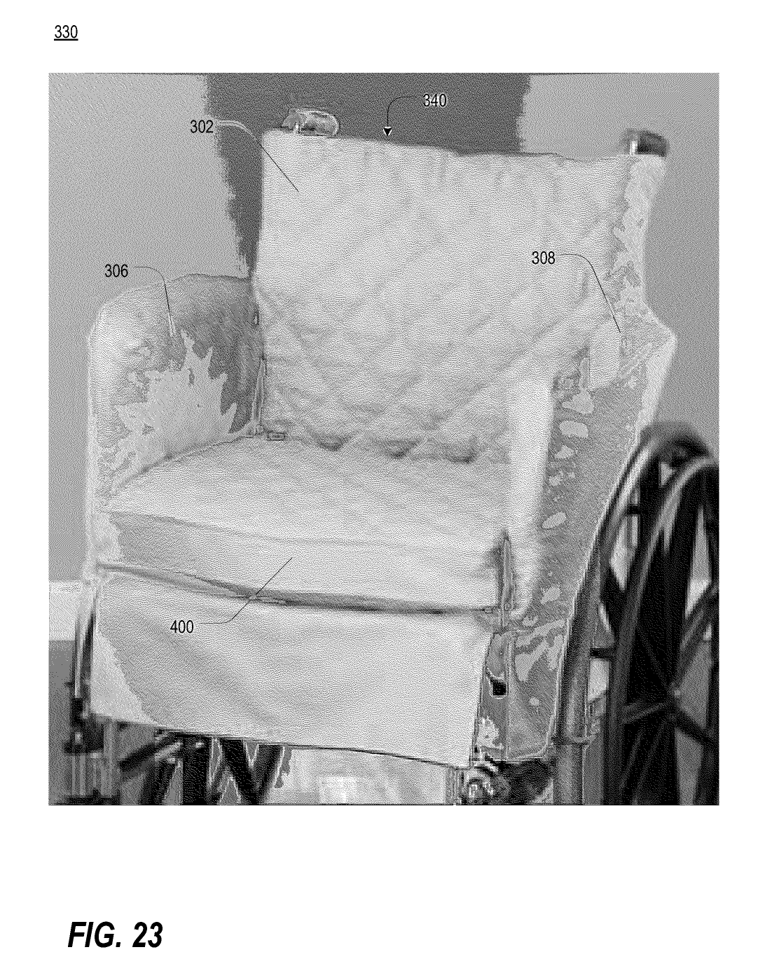

FIG. 23 is a photographic view of a standard-arm type wheelchair cover 330 that includes one or more quilted surfaces. As seen in FIG. 23, the back 302 and arms 306, 308 of the first covering member 340 and the top of the third covering member 400 include quilted surfaces.

It will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Finally, when used herein to join a list of items, “and” denotes “all of the items of the list.”

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

What is claimed is:

1. A wheelchair cover for a wheelchair comprising a seat, a back, and first and second arms, the wheelchair cover comprising:
a first covering member comprising:
a back covering portion configured to cover at least a portion of the back of the wheelchair,
a first arm covering portion configured to cover at least a portion of the first arm of the wheelchair,
a second arm covering portion configured to cover at least a portion of the second arm of the wheelchair,
a first fastener extending from an inner surface of the first arm covering portion, the first fastener being configured to secure the first arm covering portion to the first arm of the wheelchair, and
a second fastener extending from an inner surface of the second arm covering portion, the second fastener being configured to secure the second arm covering portion to the second arm of the wheelchair; and
a second covering member comprising:
a seat covering portion configured to cover at least a portion of the seat of the wheelchair,
wherein the second covering member is removably attachable to the first covering member.

2. The wheelchair cover of claim 1, wherein:
the first fastener comprises a first hook-and-loop fastener strip, and
the second fastener comprises a second hook-and-loop fastener strip.

3. The wheelchair cover of claim 1, wherein:
the first fastener comprises a first pair of hook-and-loop fastener strips, including a first hook side strip and a first loop side strip, the first hook side strip and the first loop side strip being directly attached to the inner surface of the first arm covering portion, and
the second fastener comprises a second pair of hook-and-loop fastener strips, including a second hook side strip and a second loop side strip, the second hook side strip and the second loop side strip being directly attached to the inner surface of the second arm covering portion.

4. The wheelchair cover of claim 1, wherein the first covering member further comprises:
a third fastener extending from the inner surface of the first arm covering portion, the third fastener being configured to further secure the first arm covering portion to the first arm of the wheelchair, and
a fourth fastener extending from the inner surface of the second arm covering portion, the fourth fastener being configured to further secure the second arm covering portion to the second arm of the wheelchair.

5. The wheelchair cover of claim 4, wherein:
the first fastener is located proximate a first end of the first arm covering portion,
the second fastener is located proximate a first end of the second arm covering portion,
the third fastener is located proximate a second end of the first arm covering portion, and
the fourth fastener is located proximate a second end of the second arm covering portion.

6. The wheelchair cover of claim 5,
wherein the first fastener and the third fastener are configured to secure the first arm covering portions to the first arm of the wheelchair proximate to respective ends of a first padded arm rest that is attached to the first arm of the wheelchair, and
wherein the second fastener and the fourth fastener are configured to secure the second arm covering portions to the second arm of the wheelchair proximate to respective ends of a second padded arm rest that is attached to the second arm of the wheelchair.

7. The wheelchair cover of claim 1, wherein the first covering member further comprises:
a first extension cover portion extending from a front edge of the first arm covering portion, the first extension cover portion comprising a first extension cover fastener, wherein the first extension cover portion is configured to wrap around a first hand pipe of the wheelchair such that the first arm covering portion is reversibly securable to the first hand pipe via the first extension cover fastener; and
a second extension cover portion extending from a front edge of the second arm covering portion, the second extension cover portion comprising a second extension cover fastener, wherein the second extension cover portion is configured to wrap around a second hand pipe of the wheelchair such that the second arm covering portion is reversibly securable to the second hand pipe via the second extension cover fastener.

8. The wheelchair cover of claim 7, wherein each of the first and second extension cover fasteners comprises a hook-and-loop fastener strip.

9. The wheelchair cover of claim 8, wherein:
the hook-and-loop fastener of the first extension cover portion is affixed to an inside surface of the first extension cover portion and extends lengthwise along the first extension cover portion, and
the hook-and-loop fastener of the second extension cover portion is affixed to an inside surface of the second extension cover portion and extends lengthwise along the second extension cover portion.

10. The wheelchair cover of claim 9, wherein each of the hook-and-loop fasteners of the first and second extension cover portions comprises a hook portion and a loop portion, the respective first and second arm covering portions being reversibly securable to the respective first and second hand pipes by attaching the hook portions to the loop portions.

11. The wheelchair cover of claim 7, wherein:
the first arm covering portion comprises a first inner panel and a first outer panel, the first inner panel comprising a first inner panel fastener, the first outer panel comprising a first outer panel fastener, and the first inner panel being reversibly attachable to the first outer panel via the first inner panel fastener and the first outer panel fastener, and
the second arm covering portion comprises a second inner panel and a second outer panel, the second inner panel comprising a second inner panel fastener, the second outer panel comprising a second outer panel fastener, and the second inner panel being reversibly attachable to the second outer panel via the second inner panel fastener and the second outer panel fastener.

12. The wheelchair cover of claim 1, wherein at least a portion of the first covering member includes a quilted surface.

13. The wheelchair cover of claim 1, wherein the first covering member further comprises a pocket located on a rear side of the back covering portion.

14. The wheelchair cover of claim 1, further comprising a third covering member configured to cover a cushion that is locatable on the seat of said wheelchair.

15. The wheelchair cover of claim 14, wherein at least a portion of the third covering member includes a quilted surface.

16. The wheelchair cover of claim 1, wherein:
the first covering member comprises a fabric flap extending from a bottom of the back covering portion, the fabric flap comprising a third fastener on an outside surface of the fabric flap,
the wheelchair cover further comprising a third covering member configured to cover a cushion that is locatable on the seat of said wheelchair, the wheelchair cover comprising a fourth fastener on a bottom surface of the third covering member, and
the third covering member is removably attachable to the fabric flap of the first covering member by attaching the fourth fastener to the third fastener.

17. A wheelchair cover for a wheelchair comprising a seat, a back, first and second arms, and first and second hand pipes extending from the respective first and second arms, the wheelchair cover comprising:
a first covering member comprising:
a back covering portion configured to cover at least a portion of the back of the wheelchair,
a first arm covering portion configured to cover at least a portion of the first arm of the wheelchair,
a second arm covering portion configured to cover at least a portion of the second arm of the wheelchair,
a first extension cover portion extending from a front edge of the first arm covering portion, the first extension cover portion comprising a first fastener, wherein the first extension cover portion is configured to wrap around the first hand pipe of the wheelchair such that the first arm covering portion is reversibly securable to the first hand pipe via the first fastener, and
a second extension cover portion extending from a front edge of the second arm covering portion, the second extension cover portion comprising a second fastener, wherein the second extension cover portion is configured to wrap around the second hand pipe of the wheelchair such that the second arm covering portion is reversibly securable to the second hand pipe via the second fastener; and
a second covering member comprising:
a seat covering portion configured to cover at least a portion of the seat of the wheelchair,
wherein the second covering member is removably attachable to the first covering member.

18. The wheelchair cover of claim 17, wherein each of the first and second fasteners comprises a hook-and-loop fastener strip.

19. The wheelchair cover of claim 18, wherein:
the hook-and-loop fastener of the first extension cover portion is affixed to an inside surface of the first extension cover portion along a length of the first extension cover portion, and
the hook-and-loop fastener of the second extension cover portion is affixed to an inside surface of the second extension cover portion along a length of the second extension cover portion.

20. The wheelchair cover of claim 19, wherein each of the hook-and-loop fasteners of the first and second extension cover portions comprises a hook portion and a loop portion, the respective first and second arm covering portions being reversibly securable to the respective first and second hand pipes by attaching the hook portions to the loop portions.

21. The wheelchair cover of claim 17, wherein at least a portion of the first covering member includes a quilted surface.

22. The wheelchair cover of claim 17, wherein the first covering member further comprises a pocket located on a rear side of the back covering portion.

23. The wheelchair cover of claim 17, further comprising a third covering member configured to cover a cushion that is locatable on the seat of said wheelchair.

24. The wheelchair cover of claim 23, wherein at least a portion of the third covering member includes a quilted surface.

25. The wheelchair cover of claim 17, wherein:
the first covering member comprises a fabric flap extending from a bottom of the back covering portion, the fabric flap comprising a third fastener on an outside surface of the fabric flap,
the wheelchair cover further comprising a third covering member configured to cover a cushion that is locatable on the seat of said wheelchair, the wheelchair cover comprising a fourth fastener on a bottom surface of the third covering member, and
the third covering member is directly attachable to the fabric flap of the first covering member by attaching the fourth fastener to the third fastener.
